(19) United States
(12) Patent Application Publication
(10) Pub. No.: US 2024/0402514 A1
(43) Pub. Date: Dec. 5, 2024

(54) EYEWEAR SYSTEM

(71) Applicant: Jackson River Phipps, Tampa, FL (US)

(72) Inventor: Jackson River Phipps, Tampa, FL (US)

(21) Appl. No.: 18/204,422

(22) Filed: Jun. 1, 2023

(51) Int. Cl. G02C 5/14

(52) U.S. Cl. CPC G02C 5/14; G02C 2200/02

(57) ABSTRACT

An eyewear system, as depicted in embodiments presented, includes a magnet in one temple and a magnet in at least either the second temple or the lens assembly wherein the system that can form a movement inhibiting zone. The movement inhibiting zone can include material disposed between the magnets. The movement inhibiting zone inhibits movement of one or more temples to avoid unwanted movement and damage to, or loss of, the eyewear, including during either storage, transport or use, including storage on clothing. The system can be used to protect, transport and store eyewear including relative to an exterior object. The method allows for the use of the novel eyewear system of the present invention.

### CROSS-REFERENCE TO RELATED APPLICATIONS

None.

### FIELD OF THE DISCLOSURE

The present invention relates to an eyewear system for securing eyewear, and more particularly an eyewear system using magnets that secure eyewear including prescription glasses (also referred to as spectacles), reading glasses, sunglasses and protective eyewear.

### BACKGROUND

Conventional eyewear include foldable temple members (also referred to as arms). As depicted in FIG. 1, eyewear 10 (e.g. sun glasses) are common devices and include generally the same components, including: two lenses 20 and 30, one for each eye; a bridge 40 that connects the lenses; contact portions 50 and 60 that are secured to eyewear 10 that can be in contact a wearer's nose; rims 22 and 32 that surround the lenses; and end pieces 70 and 80. The components references in the foregoing sentence comprise lens assembly 90. Thus, lens assembly 90 includes lenses 20 and 30, bridge 40, contact portions 50 and 60, rims 22 and 32 and end pieces 70 and 80. Temples 100 and 110 are connected to lens assembly 90, often by hinges 120 and 130 that are connected to end pieces 70 and 80. Hinges 120 and 130 allow temples 100 and 110 to independently extend outwardly from lens assembly 90 (as shown in FIG. 1) and also to independently fold inwardly towards each other to be in a folded position (not shown in FIG. 1). As shown in FIG. 1, hinges 120 and 130 serve to connect temples 100 and 110 to lens assembly 90. As known in the art, the hinges can include brackets, pins or screws.

As depicted in FIG. 2, eyewear 200 (e.g. reading glasses) can include additional components that are not included in eyewear 10 (as depicted in FIG. 1), including screws 140 and 150 that secure end pieces 70 and 80 to lens assembly 90. End Piece 70 includes a first portion 72 that aligns with the lenses 20 and 30 and a second portion 74 that is generally perpendicular to first portion 72 and aligns with temple 100 in the extended position. End Piece 80 includes a first portion 82 that aligns with the lenses 20 and 30 and a second portion 84 that is generally perpendicular to first portion 82 and aligns with temple 110 in the extended position. Second portion 74 of end piece 70 is connected to temple 100 by hinge 120. Second portion 84 of end piece 80 is connected to temple 200 by hinge 130. Each temple 100 and 110 includes: an ear portion that can contact a wearer's ear; a connecting portion that connects to the lens assembly 90; and a middle portion that connects the ear portion to the connecting portion. Thus, temple 100 includes ear portion 102, middle portion 104 and connecting portion 106; and temple 110 includes ear portion 112, middle portion 114 and connecting portion 116. As shown in FIG. 2, ear portions 102 and 112 can included a contact comfort layer 108 and 118, respectively, which serves to provide a more comfortable feel to a wearer of eyewear 200. As shown in FIG. 2, lens assembly 90 includes end pieces 70 and 80.

Difficulties can arise during storage, use or transport of conventional eyewear because the temple members of conventional glasses are allowed to freely open or close relative to the lens assembly. These difficulties can cause users to experience undesirable scenarios, including: eyewear stored on clothing falls or slips off and is lost or damaged; and eyewear that cannot be retrieved or stored without unwanted movement of the temples relative to the lens assembly. As a result, conventional eyewear is not protected from falling when hanging off clothing; and eyewear is not protected from accidents when being stored, transported or retrieved. Referring to FIGS. 1 and 2, which depict conventional eyewear apparatus, the temples 100 and 110 are free to move relative to the lens assembly. In these conventional technologies, such movement is unconstrained and is caused by external forces and or movement of the eyewear. Such unconstrained movement can be undesirable and can result in unwanted movement of the eyewear and or damage to, or loss of, the eyewear.

Conventional technology provides some solutions, such as storage of glasses in rigid or soft cases, which may include a clip. These solutions, however, have their own drawbacks that have not been solved, including the added bulk resulting from the case and the accompanying need for more storage space or the inability to store the glasses in a case in a desired storage area. Moreover, the use of a case inhibits or prevents the glasses from storage and transport by hanging on clothing, such as a shirt neck or pocket.

A need therefore exists for an improved eyewear system.

### SUMMARY

The present invention is directed to a novel eyewear system that uses magnets to inhibit movement, including inhibiting movement of a temple relative to a lens assembly, so as to provide a movement inhibiting zone which advantageously allows for secure storage, transport and use of eyewear.

### BRIEF DESCRIPTION OF THE DRAWINGS

FIG. 1 shows a view of a conventional eyewear apparatus that is used as sunglasses.

FIG. 2 shows a view of a convention eyewear apparatus that is used as reading glasses.

FIG. 3 shows a view of the eyewear of the present invention in an unfolded position.

FIG. 4 shows a view of the eyewear of the present invention in a folded position.

FIG. 5A shows the eyewear of the present invention that can be used to secure the eyewear on clothing.

FIG. 5B is a cross-sectional view of a portion of the eyewear depicted in FIG. 5A.

FIG. 6 illustrates an alternative embodiment of the present invention shown in an unfolded position.

FIG. 7 illustrates the eyewear of FIG. 6 in a folded position.

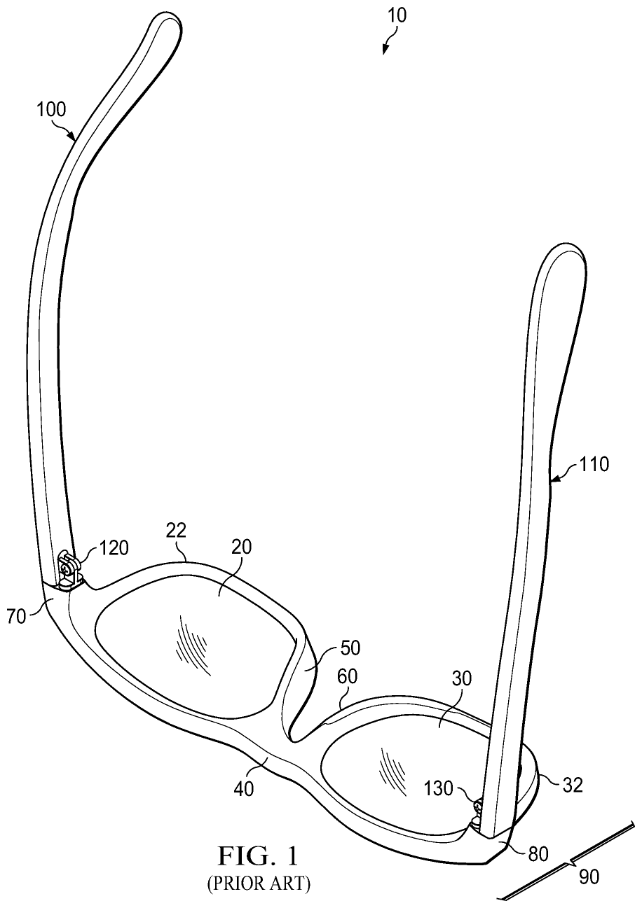

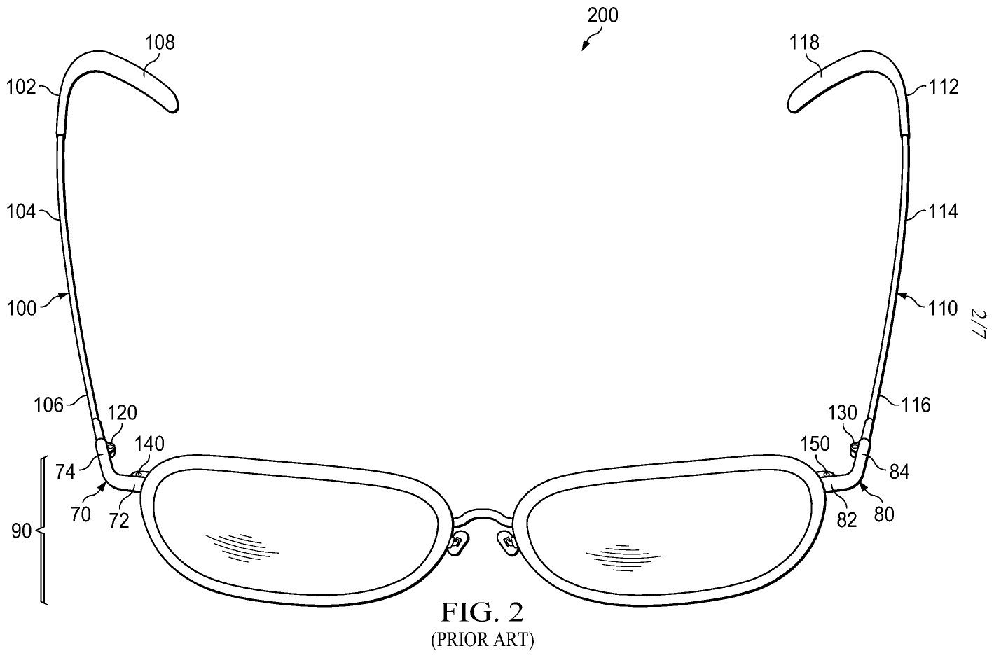

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

Embodiments of the present invention are described below with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, terms indicating relative positions are used to more clearly describe certain embodiments.

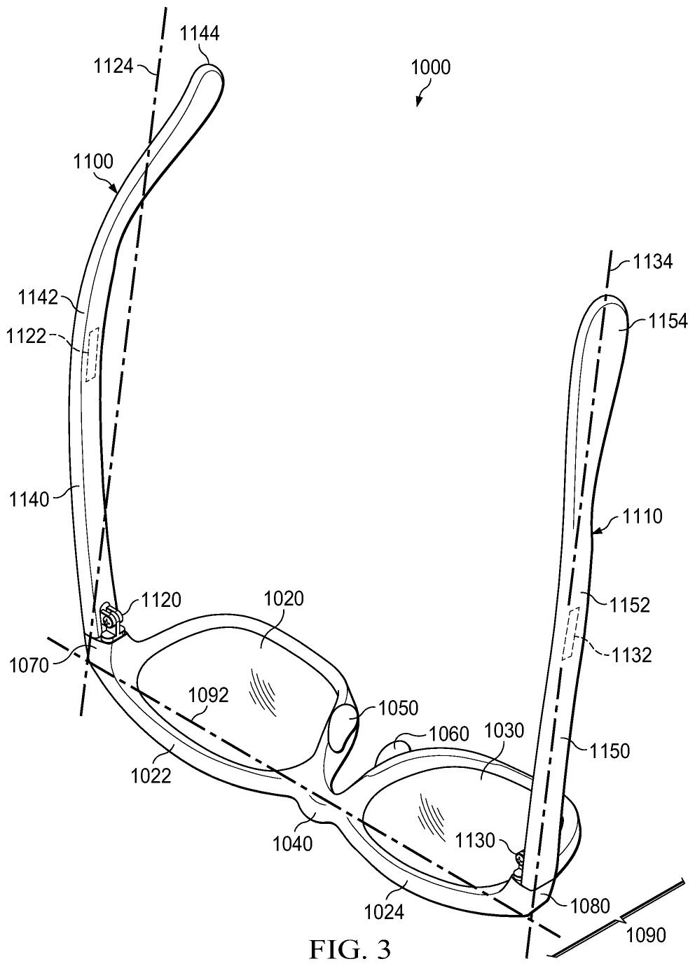

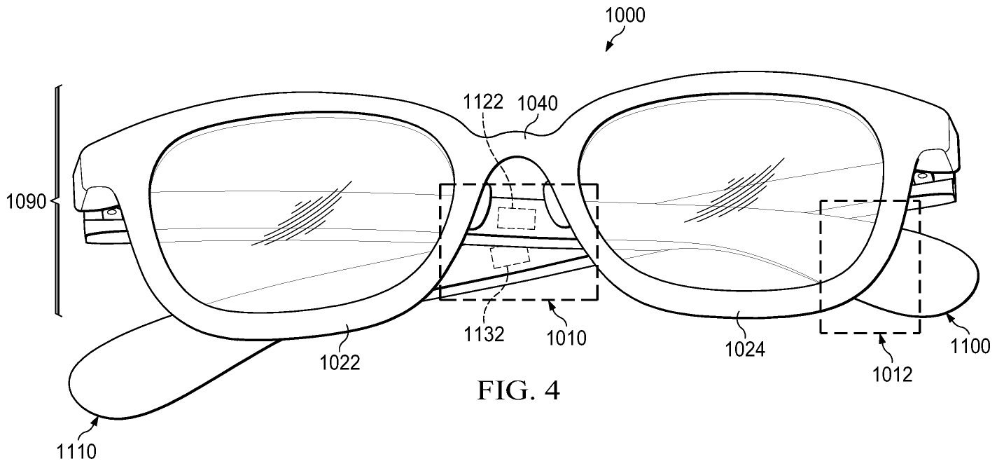

Referring to FIG. 3, an exemplary eyewear system 1000 of the present invention is illustrated in the form of an eyewear (e.g. sunglasses) with the temples in an unfolded position wherein the temples include magnets 1122 and 1132 that can be used to inhibit movement of the temples relative to the lens assembly when the temples are in a folded position as shown in FIG. 4.

As shown in FIG. 3, eyewear 1000 includes two lenses 1020 and 1030, one for each eye; a bridge 1040 that connects the lenses; contact portions 1050 and 1060 that can be in contact with a wearer's nose; rims 1022 and 1024 that surround their respective lenses; end piece portions 1070 and 1080 that can serve to connect the lens assembly 1090 to temples 1100 and 1110. Temples 1100 and 1110 are movably connected to lens assembly 1090. The movably connected feature is preferably provided by hinges 1120 and 1130. The moveable connection allows temples 1100 and 1110 to independently fold inwardly towards each other to be in a closed position. When both temples 1100 and 1110 are closed, they are in a folded position (as shown in FIG. 4). The moveable connection allows temples 1100 and 1110 to independently move outwardly away from lens assembly 1090. Each temple can be in an extended position as shown in FIG. 3, a closed position, or in a folded position as shown in FIG. 4.

As shown in FIG. 3, hinges 1120 and 1130 serve to connect temples 1100 and 1110 to lens assembly 1090.

Lens assembly 1090 is a frame that is sufficiently rigid to allow temples 1100 and 1110 to be moveably connected thereto and to allow each temple to move between an open position and independently into a closed position relative to the lens assembly 1090 or in a folded position relative to each other. Lens Assembly 1090 may include, but need not include lenses 1020 and 1030, bridge 1040, contact portions 1050 and 1060, rims 1022 and 1024 and end piece portions 1070 and 1080. Lens assembly 1090 can be in the form of any conventional eyewear, including prescription glasses, reading glasses, sunglasses and safety glasses. The components of lens assembly 1090 can be formed to be one single structure or multiple structures that are connected, including rigidly connected, flexibly connected or removeably connected.

As shown in FIG. 3, temple 1100 has a longitudinal axis 1124. Temple 1110 has a longitudinal axis 1134. In the extended or open position, the longitudinal axis of temples 1100 and 1110 are generally perpendicular to a plane that includes the longitudinal axis 1092 of lens assembly 1090.

Temple 1100 has three general portions: a connecting portion 1140 which is movably connected to lens assembly 1090; a middle portion 1142; and an ear portion 1144. Temple 1110 has three general portions: a connecting portion 1150 which is movably connected to lens assembly 1090; a middle portion 1152; and an ear portion 1154.

Temple 1100 includes a first magnet 1122. Temple 1110 includes a second magnet 1132. First magnet 1122 and second magnet 1132 are capable of being magnetically engaged or attracted to each other. Magnetic attraction can occur even though the magnets are not in direct physical contact. Magnet attraction can occur when the magnets are separated by material such as clothing. In FIG. 3, First magnet 1122 is disposed in middle portion 1142 of temple 1100 and second magnet 1132 is disposed in middle portion 1152 of second temple 1110.

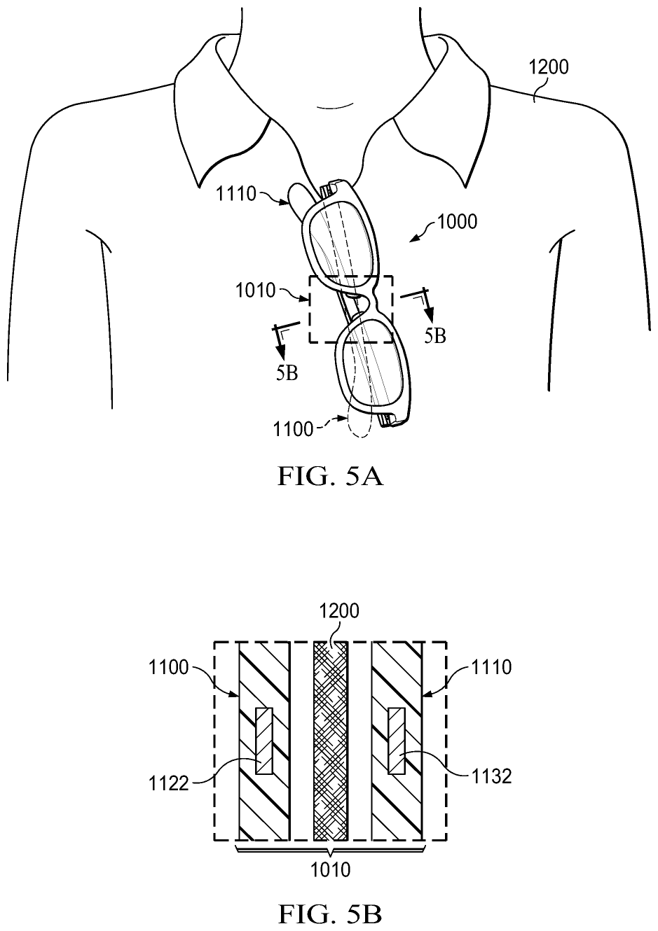

Referring to FIG. 4, exemplary eyewear apparatus 1000 is illustrated in the form of an eyewear with magnets used to inhibit movement of the temples when in a folded position. Eyewear apparatus 1000 includes lens assembly 1090 and temples 1100 and 1110 in a folded position wherein first magnet 1122 and second magnet 1132 are magnetically engaged. The magnetic engagement of first magnet 1122 and second magnet 1132 form a movement inhibiting zone 1010. Movement inhibiting zone 1010 provides a secure closure of the temples to prevent unwanted opening or movement of the temples relative to the lens assembly 1090. Material can be disposed between first magnet 1122 and second magnet 1132, including as show in FIGS. 5A and 5B.

Optionally, and depending upon the design of the eyewear, one or more additional movement inhibiting zones can be formed. In FIG. 4, a second movement inhibiting zone 1012 is formed as a result of the formation of movement inhibiting zone 1010. Movement inhibiting zone 1012 can be formed by mechanical force resulting from the formation of movement inhibiting zone 1010. Material can be disposed within movement inhibiting zone 1012 between temple 1100 and lens assembly 1090.

As shown in FIG. 4, movement inhibiting zone 1010 can be created near bridge 1040 and a second movement inhibiting zone 1012 can created near or on rim 1024.

Eyewear 1000 can include magnets of various shapes and sizes so as to adjust the strength of the magnet engagement as desired, including based upon the expected or intended use of eyewear 1000. For example, construction workers may prefer a stronger magnetic engagement so as to secure eyeglasses to clothing whereas for environments with less severe forces, it may be preferable to have a weaker magnetic engagement. Preferably, the magnetic engagement is sufficient to prevent disengagement from normal human activities such as walking or bending. Movement inhibiting zone 2010 is preferably sufficiently dimensioned so as to receive clothing or other material between first magnet 1122 and second magnet 1132 while maintaining their magnetic engagement and inhibiting movement. The movement inhibited can be of the eyewear 1000 relative to eyewear 1000, material, components of eyewear 1000 or an outside object.

Multiple magnets may be used in eyewear 1000, including in one or both temples and in lens assembly 1090. The location of the magnets within the temples and lens assembly can be adjusted so as to form one or more inhibiting zones, including depending up the desired location for such zones, specific environments of use of the eyewear and specific storage and transport applications.

As shown in FIG. 4, a second inhibiting zone 1012 can be formed through merely mechanical forces between one of the temples and the lens assembly when the first inhibiting zone 1010 has been formed.

As shown in FIG. 5A, eyewear 1000 can be used to form inhibiting zone 1010 that can include material 1200, such as clothing (e.g. a shirt), disposed between a first magnet 1122 and a second magnet 1132. Eyewear 1000 includes magnets 1122 and 1132 to form inhibiting zone 1010 that can inhibit movement of the eyewear 1000 relative to material 1200.

As shown in FIG. 5B, which is a cross section of FIG. 5A, first temple 1100 and second temple 1110 can be separated by material 1200 but still form an inhibiting zone 1010.

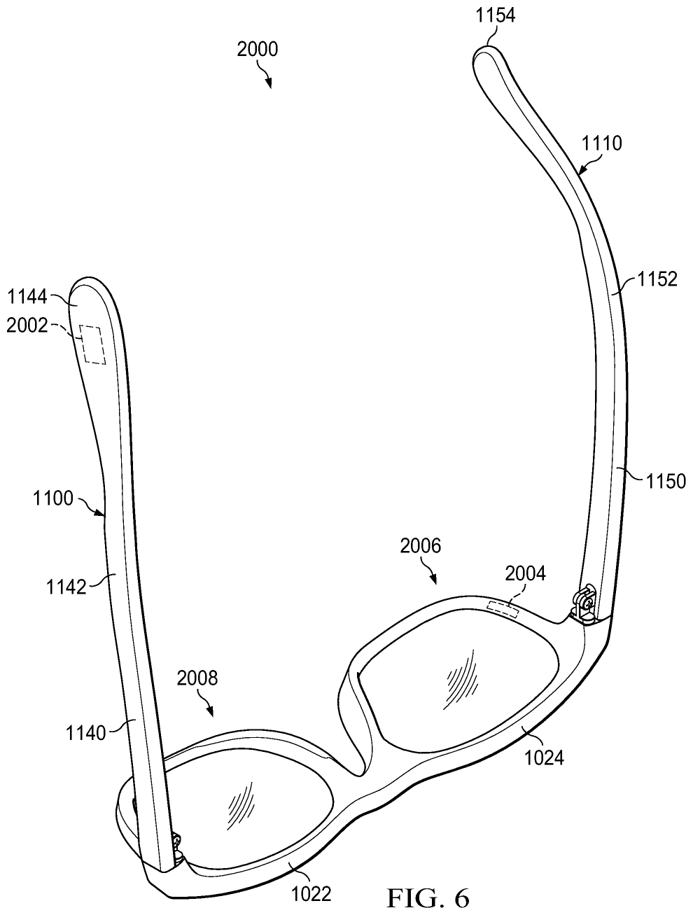

As shown in FIG. 6, an alternative embodiment of the invention includes eyewear 2000 (shown in an open position). Eyewear 2000 includes many of the same components of eyewear 1000 as shown in FIG. 3 but differs in the placement of the magnets. In eyewear 2000, a first magnet 2002 is part of the ear section 1144 of temple 1100 and a second magnet 2004 is part of lower portion 2006 of rim 1024.

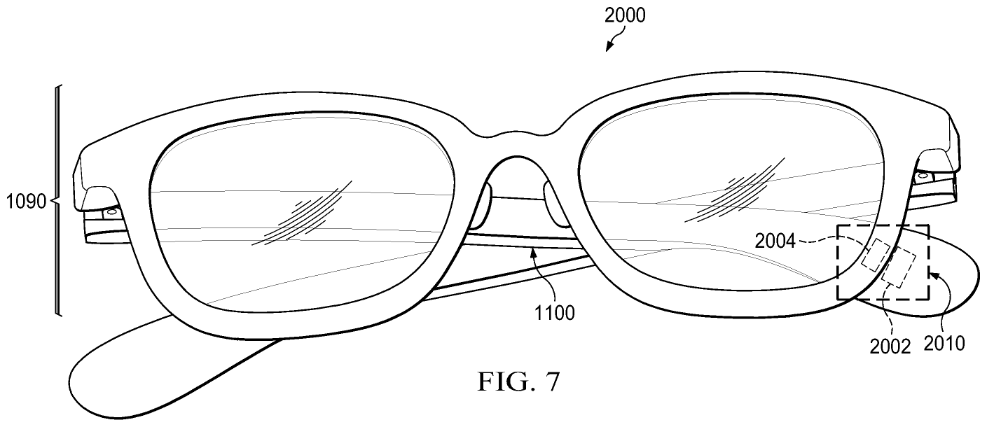

As shown in FIG. 7, eyewear 2000 of FIG. 6 is shown in a closed position. Temple 1100 can be folded relative to lens assembly 1090 so that magnet 2002 is magnetically engaged with magnet 2004 in lens assembly 1090. Magnet 2002 and magnet 2004 can form a movement inhibiting zone 2010.

The magnets used in eyewear 2000 can be disposed in various locations so as to afford alternative or additional magnetic connections. For example, the relative locations of magnets 2002 and 2004 can be swapped vis a vis temple 1110 and lower portion 2008 of rim 1022. In other words, first magnet 2002 can be disposed within or connected to ear portion 1154 of temple 1110 and second magnet 2004 can be disposed within or connected to lower portion 2008 of rim 1022. Additional magnets can be included in eyewear 2000 to form additional opportunities for magnetic connections and for the formation of alternative or additional movement inhibiting zones. Additional magnets disposed in a temple are preferably arranged along the longitudinal axis with their polarities aligned.

The movement inhibiting zones of the present invention include the magnetic connection field between a first magnet and a second magnet as well as any additional 3-dimensional space that a) inhibits movement of a material between either a first temple or a second temple and a lens assembly; b) inhibits movement of a material between a first temple and a second temple and a lens assembly; or c) inhibits movement of a material between a first temple and a second temple. The system of the present invention can form more than one movement inhibiting zone. For example, when a first magnet is disposed within said first temple and a second magnet is disposed within said second temple and both temples are in a closed position such that they fold over each other, the system creates a first movement inhibiting zone between said first and second magnets and in the 3-dimensional space area surrounding that space between which can result from the mechanical force of the folded temples either adjacent to the location of the magnets or at one or more other locations such as between the ear portion of one or more temples and the lens assembly. These other locations for a secondary movement inhibiting zone can include a material disposed therein.

The first magnet and the second magnet of the present invention need not be in direct contact so as to form a movement inhibiting zone. Indeed, the magnets may be incased in other material, including disposed within the material used to manufacture the temples. The magnets can form a movement inhibiting zone when they are in sufficiently close proximity to each other.

The designations of first and second, including in reference to temples and magnets, can be reversed. In other words, the present invention is not limited to a left side or right side perspective. Thus, a first temple can be on a wearer's right side or left side, and vice versa; and the second temple would be on a wearer's side that is not the side where the first temple is located.

The lens assembly of the present invention need not include lenses, which can be added by a manufacturer, eye care professional, designer or wearer after the system of the present invention has been made, used, sold, offered for sale, imported or exported.

The magnets of the present invention can be disposed within any eyewear component, on any eyewear component, or affixed thereto either permanently, adjustably, slideably or removeably. The magnets of the present invention can be removeably connected to the eyewear system of the present invention. The magnets of the present invention can be moveably connected to the eyewear system of the present invention, including so as to allow the magnets to be moved along the longitudinal axis of a temple. The magnets of the present invention can be adjustably connected to the eyewear system of the present invention, including that they may be rotated relative to a component so as to allow for a desired configuration. One preferred embodiment of the present invention includes magnets in the temples that are rotatably connected to the temples and can be adjusted to alter the location or dimensions of a movement inhibiting zone.

The eyewear system of the present invention can afford additional advantages by allowing eyewear to be magnetically engaged to its surrounding environment. Such external engagements can include creating a magnetic engagement with a magnet placed on or secured to a side table, a wall or a case. These magnetic engagements with an external magnet can afford the ability to store and locate eyewear so as to avoid loss or misplacement of the eyewear. Such engagements can also allow for secure storage in a work environment, such as on protective eyewear wherein the location of such eyewear can be stored near a job site requiring eye protection.

The eyewear system of the present invention includes a lens assembly, a first temple and a second temple, wherein each of said temples is moveably connected to said lens assembly so as to allow said temples to move relative to said frame assembly, including allowing said temples to move between an open position and a closed position relative to said lens assembly and also into a folded position wherein said first temple and said second temple are both in a closed position relative to said lens assembly. The eyewear system further comprises a first magnet secured to said first temple and a second magnet secured to at least either the second temple or the lens assembly; such that the first and second magnets can attract each other when in close proximity so as to form a movement inhibiting zone.

The eyewear system thus can involve the second magnet secured to the second temple and the first and second magnets can attract each other in a folded position to form a movement inhibiting zone. A method of using this embodiment of the eyewear system comprises the steps of folding one temple towards the lens assembly into a folded position and then folding the other temple toward the lens assembly into a folded position such that the magnets engage and form a movement inhibiting zone. The method can further include the step of placing material between the two temples such that the movement inhibiting zone inhibits movement of the eyewear relative to the material.

A method of storing the eyewear system can include placing the eyewear near an external magnet so as to form a movement inhibiting zone between one of the magnets in the system and the external magnet. The external magnet can be fixed to an object, such as a table or wall, or to another structure, such as a clip or an eyeglass case.

The eyewear system can thus alternatively involve the second magnet secured to the lens assembly and the first and second magnets being able to attract each when the temple with the magnet is in a closed position to form said movement inhibiting zone. A method of using this embodiment of the system of the present invention can include the steps of folding the temple with the first magnet towards the lens assembly and forming a movement inhibiting zone between the magnets.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

What is claimed is:

1. An eyewear system including a lens assembly, a first temple and a second temple, wherein each of said temples is moveably connected to said lens assembly so as to allow said temples to move relative to said frame assembly, including allowing said temples to move between an open position and a closed position relative to said lens assembly and also into a folded position wherein said first temple and said second temple are both in a closed position relative to said lens assembly, said eyewear system further comprising:
a first magnet secured to said first temple and a second magnet secured to at least one of the following: said second temple or said lens assembly;
and wherein said first and second magnets can attract each other when in close proximity so as to form a movement inhibiting zone.

2. The eyewear system of claim 1 wherein said second magnet is secured to said second temple and said first and second magnets can attract each other in a folded position to form said movement inhibiting zone.

3. The eyewear system of claim 2 wherein said first and second temples each include a connecting portion, a middle portion and an ear portion; wherein said first magnet is in said middle portion of said first temple and said second magnet is in said middle portion of said second temple.

4. The eyewear system of claim 2 wherein material can be disposed between said first and second temples to form a movement inhibiting zone when in a folded position that inhibits movement of said eyewear system relative to said material.

5. The eyewear system of claim 2 wherein a second movement inhibiting zone is formed in a location apart from said movement inhibiting zone without the use of magnets.

6. The eyewear system of claim 2 wherein additional magnets are included so as to form a second movement inhibiting zone using magnets.

7. A method of using the eyewear system of claim 2 comprises the following steps:
folding said first temple towards said lens assembly;
folding said second temple towards said lens assembly such that the temples are in a folded position; and
forming a movement inhibiting zone between said magnets.

8. The method of claim 7 further comprising the step of disposing material between said first temple and said second temple such that the eyewear is inhibited from moving relative to said material.

9. A method of storing the eyewear system of claim 2 comprising the step of placing said eyewear near an external magnet so as to form a movement inhibiting zone between one of the magnets in said system and said external magnet.

10. The eyewear system of claim 1 wherein said second magnet is secured to said lens assembly and said first and second magnets can attract each other when said temple is in a closed position relative to said lens assembly to form said movement inhibiting zone.

11. The eyewear system of claim 10 wherein said first temple includes a connecting portion, a middle portion and an ear portion and said lens assembly includes a first and second rim, each rim having a lower portion, wherein said first magnet is contained within said ear portion of said first temple and said second magnet is contained within said lower portion of said second rim such that said movement inhibiting zone can be formed between said ear portion of said first temple and said lower portion of said second rim within said lens assembly when said temple is in a closed position relative to said lens assembly.

12. The eyewear system of claim 10 wherein material can be disposed between said first temple and said lens assembly to form a movement inhibiting zone when said temple is in a closed position that inhibits movement of said eyewear system relative to said material.

13. The eyewear system of claim 10 wherein additional magnets are included so as to form a second movement inhibiting zone using magnets.

14. A method of using the eyewear system of claim 10 comprises the following steps:
folding said first temple towards said lens assembly; and
forming a movement inhibiting zone between said magnets.

15. The method of claim 14 further comprising the step of disposing material between said first temple and said lens assembly such that the eyewear is inhibited from moving relative to said material.

16. A method of storing the eyewear system of claim 10 comprises the step of placing said eyewear near an external magnet so as to form a movement inhibiting zone between one of the magnets in said system and said external magnet.

17. The eyewear system of claim 1, wherein the eyewear is selected from the group consisting of: sun glasses, prescription glasses, reading glasses and protective eyewear.

18. An eyewear apparatus that employs the system of claim 1.

19. An eyewear apparatus that employs the system of claim 2.

20. An eyewear apparatus that employs the system of claim 10.
